(19) United States
(12) Patent Application Publication
(10) Pub. No.: US 2008/0197720 A1
(43) Pub. Date: Aug. 21, 2008

(54) VIBRATING-TYPE MOTOR

(75) Inventors: Noboru MATSUMOTO, Hino City (JP); Keishi OHSHIMA, Miura City (JP); Yoshinori MIZOGUCHI, Chofu City (JP)

Correspondence Address: ROSSI, KIMMS & McDOWELL LLP., P.O. BOX 826, ASHBURN, VA, 20146-0826, US

(73) Assignee: FUJI ELECTRIC SYSTEMS CO., LTD., Tokyo (JP)

(21) Appl. No.: 12/035,091

(22) Filed: Feb. 21, 2008

(30) Foreign Application Priority Data
Feb. 21, 2007 (JP) 2007-040998
Sep. 5, 2007 (JP) 2007-230172

(51) Int. Cl. H02K 33/00

(52) U.S. Cl. 310/15

(57) ABSTRACT

A vibrating-type motor is provided, in which a restoring force is reduced without reducing a thrust increasing effect by auxiliary magnets, thereby to reduce the size and expense of the motor while increasing efficiency. The vibrating-type motor includes a moving part having a main magnet and auxiliary magnets individually junctioned coaxially to two axial end portions of the main magnet, an exciting yoke including two leg portions opposed to the moving part through a gap and arranged coaxially with the moving part, an exciting coil wound on the exciting yoke for generating a magnetic flux in the leg portions, and a back yoke arranged to confront the exciting yoke with the moving part located between the back yoke and the exciting yoke, wherein outer-side end portions of the exciting yoke extend past axial end portions of the back yoke.

### BACKGROUND

The present invention relates to a vibrating-type motor, which can be used, for example, in a vibrating-type compressor for a Stirling freezer.

A moving-magnet type linear motor (hereinafter simply referred to as a “moving-magnet type motor”) has conventionally been employed as a vibrating-type motor. FIGS. 6 and 7 are schematic diagrams that explain a driving principle of a moving-magnet type motor, and show portions of a section taken along a center axis C of a substantially cylindrical motor. As shown in FIG. 6, the motor includes an exciting yoke 101, an exciting coil 102, a back yoke 103, and a moving part 104. The moving part 104 is made of a cylindrical permanent magnet arranged in a gap portion between the exciting yoke 101 and the back yoke 103 and magnetized with different poles on the inner circumference side and the outer circumference side. A magnetic flux 201 generated by the moving part 104 is also illustrated. A conventional casing for supporting the moving part 104 is provided but not illustrated.

In most moving-magnet type motors as shown, a single permanent magnet having a magnetized single pole is used as the moving part 104, which is integrally connected to a piston (not shown). The moving part 104 has its two axial end portions confined within the leg width of the exciting yoke 101. In a case where the moving part 104 has its outer circumference magnetized to the N-pole and its inner circumference side magnetized to the S-pole, as shown in FIG. 6, the magnetic flux 201 generated from the outer circumference side returns around the outer side of the moving part 104 to the inner circumference side. In the two axial end portions of the moving part 104, therefore, the aforementioned magnetic flux 201 becomes equivalent to that which would be generated if the electric currents were fed opposite to that of the direction normal to the drawing. This magnetic flux is called the equivalent current I_{M} of the permanent magnet.

When a magnetic flux Φ is generated by feeding an AC current to the exciting coil 102 and when this flux Φ is linked to a gap G, in which the equivalent current I_{M} exists, as shown in FIG. 7, the moving part 104 arranged in the gap G is reciprocated according to Fleming's lefthand rule by the force (thrust) in the lateral direction of the drawing. The aforementioned thrust F can be simply calculated according to following Formula 1:

F=B·2IM·LM,

wherein letter B designates a magnetic flux density of the magnetic flux Φ generated in the gap G, and L_{M} designates an average length in the circumferential direction of the moving part 104. In Formula 1, the equivalent current I_{M} is doubled unlike the ordinary B·I·L rule, because the equivalent I_{M} exists in this model at two portions of the two axial end portions of the moving part 104.

On the other hand, the moving part 104 is provided with a mechanical spring (e.g., a coil spring or a leaf spring) having a proper spring force in the not-shown axial direction (as shown in JP-A-2005-9397). This is because the input power can be suppressed by driving the moving part 104 at the resonance point of the mechanical vibrations. Generally, a Stirling freezer is run at a relatively low frequency of 40 to 80 Hz. The natural frequency f of a simple spring-mass system is given for a spring constant k and a mobile mass m by the following Formula 2:

f=½π√k/m.

In a case where the vibrating-type motor of the invention is used as a compressor, moreover, the spring constant k is expressed, by the following Formula 3:

k=kₛₚ+k_{mag}+k_{gas},

wherein:

kₛₚ designates a spring constant by the mechanical spring;

k_{mag} designates a spring constant by the restoring force of the moving part magnet; and

k_{gas} designates a spring constant by a compressed gas.

Of these, the spring constant k_{gas} is substantially determined by the filling pressure and the compression ratio of the compressed gas in accordance with the freezing output required, so that it is difficult to intentionally adjust. In case the moving part 104 is a single permanent magnet having a magnetized single pole, as shown in FIG. 6 and FIG. 7, the restoring force of the magnet hardly acts in the moving range, so that no practical consideration is needed for the constant k_{mag}. As a result, the mechanical spring constant kₛₚ has a wide adjustable range so that it is relative easy to design.

In addition, in order that the thrust F may be increased without changing the body of the motor (L_{M}=constant), the magnetic flux density B or the equivalent current I_{M} of the gap may be increased, as apparent from Formula 1. At first, in order to increase the magnetic flux density B, it is necessary to decrease the gap length of the gap or to increase the exciting current to flow through the exciting coil 102. However, the former method has a problem that the moving part 104 and its supporting member are made thin, which can easily result in a reduction in strength and a rise in manufacturing costs, and the latter method has a problem that a Joule's heat loss I²R) is increased thereby inviting a drop in performance.

In order to increase the equivalent current I_{M}, on the other hand, it is possible not only to change the thickness of the permanent magnet as the moving part 104 but also to use a permanent magnet having a stronger magnetic force. However, both of these options would raise manufacturing expenses.

Another method for increasing the thrust F is shown in FIG. 8. In this example of a moving-magnet type motor, cylindrical auxiliary magnets 106 and 107, which are magnetized in the opposite direction to the main magnet 105, are coaxially and integrally junctioned to the two axial end portions of a cylindrical main magnet 105 so that a moving part 104A is formed to virtually increase the equivalent current I_{M}. U.S. Pat. Nos. 5,148,066 and 4,937,481, for example, illustrate that it is well known to include a moving part having a main magnet and a pair of auxiliary magnets. In the example illustrated in FIG. 8, the magnetic fluxes cancel each other in the unexcited state at the junction portions between the main magnet 105 and the auxiliary magnets 106 and 107 so that the retentiveness at the neutral position of the moving part 104A is made stronger than that of the structure of FIG. 6 and FIG. 10. This results in an advantage in that so-called “self-centering” is facilitated.

FIG. 9 is a schematic diagram of the moving-magnet type motor described in U.S. Pat. No. 5,148,066. The motor illustrated in FIG. 9 includes a back yoke 201, an exciting coil 202, an exciting yoke 203, a moving part 204, a main magnet 205, and auxiliary magnets 206 and 207. The motor is coupled to a Stirling engine 300 located within a casing 301 via a piston 302. A displacer 303 is also located within the casing 301. A neutral position 210 is designated for the moving part 204. In a case where the moving part 204 is displaced in the axial direction, according to the prior art shown in FIG. 9, a strong restoring force acts on the moving part 204. As a result, a piston stroke may be unable to be sufficiently retained.

As a countermeasure for relaxing the aforementioned restoring force, it is disclosed in FIGS. 7A and 8A in U.S. Pat. No. 5,148,066 that the shape and structure are changed by a method of forming the auxiliary magnets into a triangular shape or thinning the same. In order to design those shapes and so on to the optimum values, the parameters are so increased that it is difficult to design the auxiliary magnets. If the method of making the auxiliary magnets triangular or the like is adopted, moreover, the equivalent current is decreased and raises a problem that not only the restoring force but also the thrust increasing effect is lowered.

On the other hand, in case no countermeasure is taken for relaxing the restoring force, the strong restoring force acts on the main magnet and the auxiliary magnets. This makes it necessary to consider the constant k_{mag}, as expressed by Formula 3. As the constant k_{mag} increases, it is apparent from Formula 2 and Formula 3 that the range required for designing the mechanical spring to adjust the resonation of the mechanical vibrations is narrowed to make the design of a low-frequency resonation difficult.

In this case, it is also conceivable to reduce the radial retentiveness of the support spring (or the mechanical spring) to thereby weaken the entire spring force, or to increase the mobile mass in Formula 2. However, these countermeasures still have problems in that the piston and the cylinder cannot be supported in a non-contact manner, and that the entire structure is heavy and large.

In view of the above, it would be desirable to provide a vibrating-type motor, in which only a restoring force is reduced without reducing a thrust increasing effect by auxiliary magnets, thereby reducing size while increasing efficiency.

### SUMMARY OF THE INVENTION

The invention provides a vibrating-type motor, in which only a restoring force is reduced without reducing a thrust increasing effect by auxiliary magnets, thereby reducing size while increasing efficiency. Specifically, a vibrating-motor is provided that includes a moving part having a main magnet and auxiliary magnets individually junctioned coaxially to axially end portions of the main magnet at junction positions, an exciting yoke including two leg portions opposed to the moving part through a gap and arranged coaxially with the moving part, an exciting coil wound on the exciting yoke for generating a magnetic flux in the leg portions, and a back yoke arranged to confront the exciting yoke with the moving part located between the back yoke and the exciting yoke, wherein outer-side end portions of faces of the leg portions that are closest to the moving part extend past axial end portions of the back yoke.

The exciting yoke is disposed on a radially outer side of the moving part, and the back yoke is disposed on a radially inner side of said moving part or, alternatively, the exciting yoke is disposed on a inner side of the moving part, and the back yoke is disposed on a radially outer side of said moving part.

In one preferred structure, the distances between the axial end portions of the back yoke and the outer-side end portions are equalized.

Moreover, the distances between the axial end portions of the back yoke and the outer-side end portions can be made 30% or less of the axial width of the faces of the leg portions of the exciting yoke that are closest to the moving part.

Further, the distance between the junction portions of the main magnet and the auxiliary magnets and the distance between the central portions of the faces of the two leg portions that are closest to the moving part can be made equal to each other.

In addition, the distance between the junction portions of the main magnet and the auxiliary magnets can be made larger than the distance between the central portions of the faces of the two leg portions that are closest to the moving part.

Still further, the axial length of the moving part can be made larger than the distance between the outer-side end portions of the faces of the leg portions that are closest to the moving part.

According to the invention, it is possible to provide a vibrating-type motor, which can relax the restoring force due to the permanent magnet of the moving part while substantially keeping the thrust, as might otherwise be caused by the exciting current, of the moving part, and which can be small in size, light in weight, and low in price.

### BRIEF DESCRIPTION OF THE DRAWINGS

The invention will be described with reference to certain preferred embodiments thereof and the accompanying drawings, wherein:

FIG. 1 is a schematic diagram showing a first embodiment of the invention;

FIG. 2 is a schematic diagram showing a second embodiment of the invention;

FIG. 3 is a diagram showing relations between the displacement and the thrust of the moving part in the embodiments;

FIG. 4 is a diagram showing relations between the displacement and the restoring force of the moving part in the embodiments;

FIG. 5 is a diagram showing relations between the displacement and the restoring force of the moving part in case the back yoke lengths in the embodiments are changed;

FIG. 6 is a schematic diagram for explaining a driving principle of a moving-magnet type motor;

FIG. 7 is a schematic diagram for explaining a driving principle of a moving-magnet type motor;

FIG. 8 is a schematic diagram showing the prior art; and

FIG. 9 is a schematic diagram showing the prior art.

### DETAILED DESCRIPTION OF THE PREFERRED EMBODIMENTS OF THE INVENTION

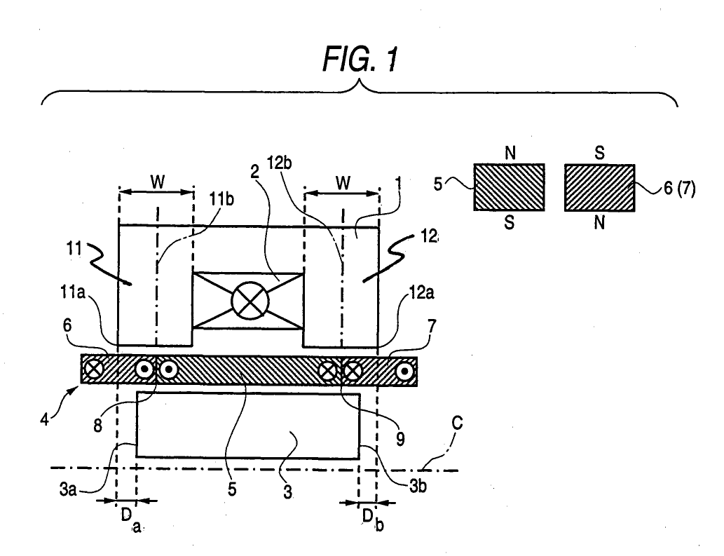

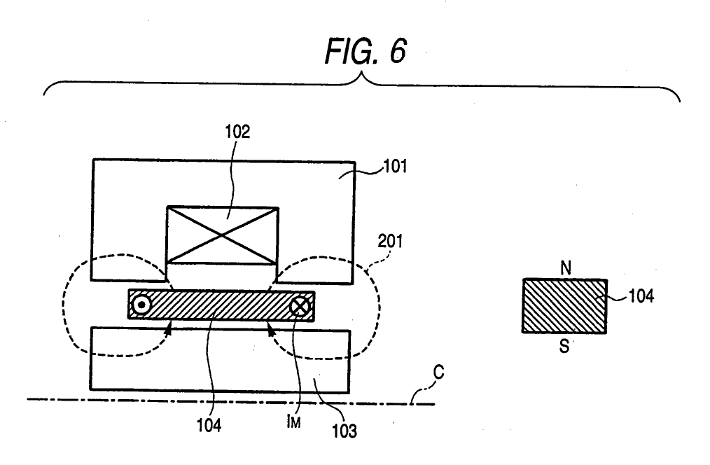

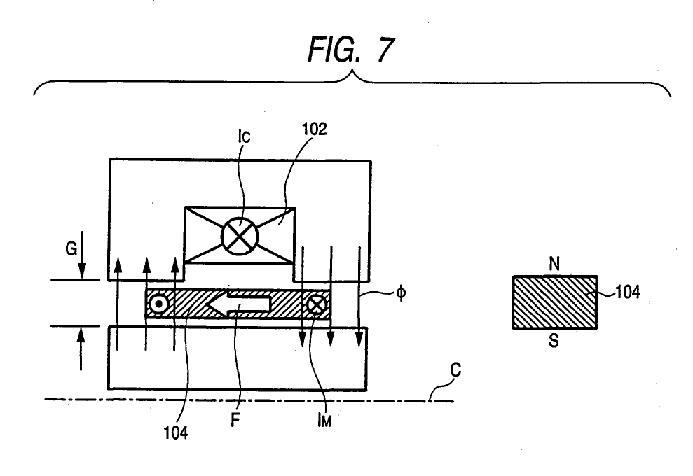

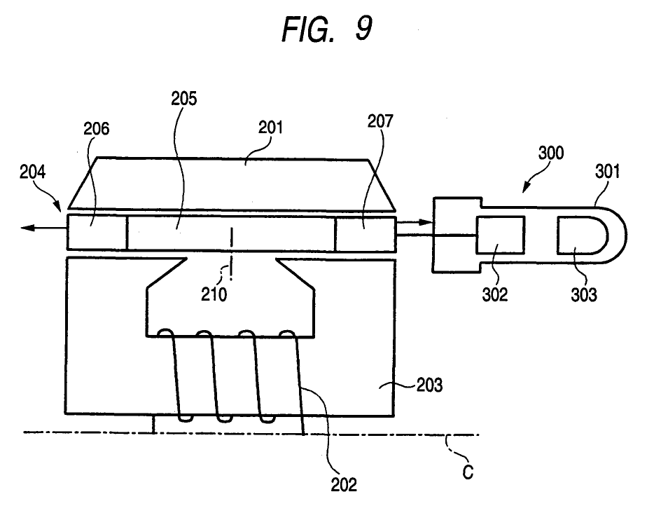

FIG. 1 is a schematic diagram illustrating a first embodiment of the invention. As in FIGS. 6 to 9 discussed above, FIG. 1 illustrates a portion of a section taken along a center axis C of a substantially cylindrical motor. FIG. 1 illustrates a motor that includes an exciting yoke 1, an exciting coil 2 wound on the exciting yoke 1, a back yoke 3, and a moving part 4. The moving part 4 is made of a permanent magnet arranged in the gap portion between the exciting yoke 1 and the back yoke 3. A conventional casing for supporting the moving part 4 is not shown in the drawing.

As shown in FIG. 1, the moving part 4 is constructed by connecting auxiliary magnets 6 and 7 coaxially and integrally to the two axial end portions of main magnet 5 at junction positions 8 and 9, wherein the main magnet 5 has its outer circumference side to the N-pole and its inner circumference side to the S-pole. The auxiliary magnets 6 and 7 are magnetized in the direction opposite to that of the main magnet 5. The main magnet 5 and the auxiliary magnets 6 and 7 are preferably composed of a rare earth element such as neodymium or samarium.

The exciting yoke 1 is formed by laminating a plurality of sheets such as iron sheets or silicon steel sheets. In case in which an alternating magnetic field is applied, as in a vibrating-type motor, the exciting yoke 1 is preferably insulated in a direction perpendicular to the magnetic flux by using the laminated steel sheets or the like, because eddy currents perpendicular to the magnetic flux are established that deteriorate performance.

The back yoke 3 has its end portions 3a and 3b positioned, as shown, on the inner side of the outer-side portions 11a and 12a of the faces 11f and 12f of the leg portions 11 and 12 that are closest to the moving part 4. In short, the axial length of the back yoke 3 is shorter than the distance between the outer-side end portions 11a and 12a. In other words, the two outer-side end portions 11a, 12a of the faces 11f and 12f of the leg portions 11, 12 that are closest to the moving part 4 extend past the axial end portions 3a, 3b of the cylindrical back yoke 3.

Moreover, the back yoke 3 is set such that the distance Da between its end portion 3a and the outer-side end portion 11a of the face 11f of the leg portion 11 to the moving part 4 is equal to the distance Db between its end portion 3b and the outer-side end portion 12a of the face 12f of the leg portion 12 to the moving part 4.

On the other hand, the axial length of the entire moving part 4 is larger than the distance between the outer-side end portions 11a and 12a of the faces 11f and 12f of the leg portions 11 and 12 that are closest to the moving part 4, and the two end portions of the moving part 4 (i.e., the individual one-end portions of the auxiliary magnets 6 and 7) are positioned on the outer side of the outer-side end portions 11a and 12a.

Moreover, the junction positions 8 and 9 between the main magnet 5 and the auxiliary magnets 6 and 7 are positioned on the inner side of the outer-side end portions 11a and 12a. Here, the junction positions 8 and 9 may also coincide with the central portions 11b and 12b of the closest faces 11f and 12f in order to simplify the design.

The leg portions 11 and 12 of the exciting yoke may also be tapered to have smaller or larger widths on the side of the moving part 4. Alternatively, the leg portions 11 and 12 may also be stepped to make the axial width of the closest faces 11f and 12f wider or narrower than the root end portions of the leg portions 11 and 12. This is because the positions of the end portions 3a and 3b of the back yoke 3 are also arranged, in that case, on the inner side of the outer-side end portions 11a and 12a of the closest faces 11f and 12f so that similar effects can be attained.

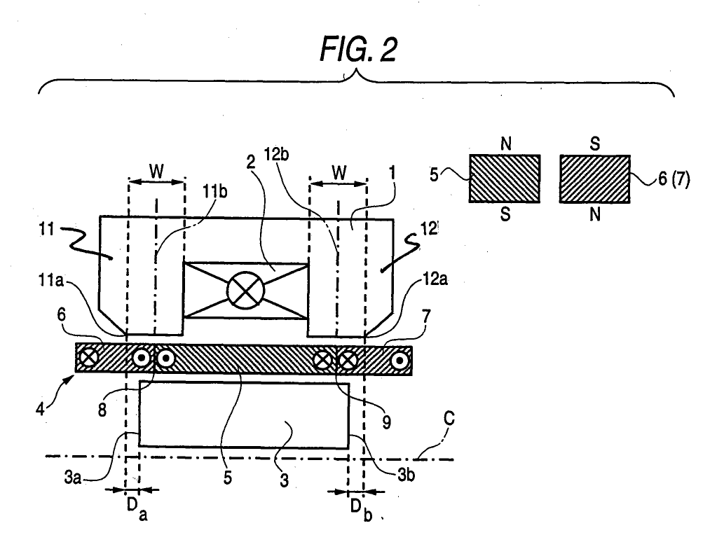

FIG. 2 shows a second embodiment, in which the leg portions 11 and 12 of the exciting yoke are tapered narrow only on the axial outer sides of the moving part 4. The back yoke 3 has its end portions 3a and 3b positioned, as shown, on the inner side of the outer-side end portions 11a and 12a of the faces 11f and 12f of leg portions 11 and 12 that are closest to the moving part 4. In short, the axial length of the back yoke 3 is shorter than the distance between the outer-side end portions 11a and 12a. Moreover, the back yoke 3 is set such that the distance Da between its end portion 3a and the outer-side end portion 11a of the closest face 11f of the leg portion 11 to the moving part 4 is equal to the distance Db between its end portion 3b and the outer-side end portion 12a of the closest face 12f of the leg portion 12 to the moving part 4.

On the other hand, the axial length of the entire moving part 4 is larger than the distance between the outer-side end portions 11a and 12a of the closest faces 11f and 12f, and the two end portions of the moving part 4 (i.e., the individual one-end portions of the auxiliary magnets 6 and 7) are positioned on the outer side of the outer-side end portions 11a and 12a. Moreover, the junction positions 8 and 9 between the main magnet 5 and the auxiliary magnets 6 and 7 are positioned on the inner side of the outer-side end portions 11a and 12a.

Next, the description is made on the relations between the displacement of the moving part 4 and a thrust and a restoring force.

Here, the distances from the end portions 3a and 3b of the back yoke 3 to the outer-side end portions 11a and 12a of the closest faces 11f and 12f are designated as D (as referred to Da or Db in FIG. 1 and FIG. 2). Moreover, the axial widths of the closest faces 11f and 12f are designated as W (as referred to FIG. 1 and FIG. 2). On the other hand, the central portions 11b and 12b of the closest faces 11f and 12f are located at the central portions of the widths W, as shown in FIG. 1 and FIG. 2.

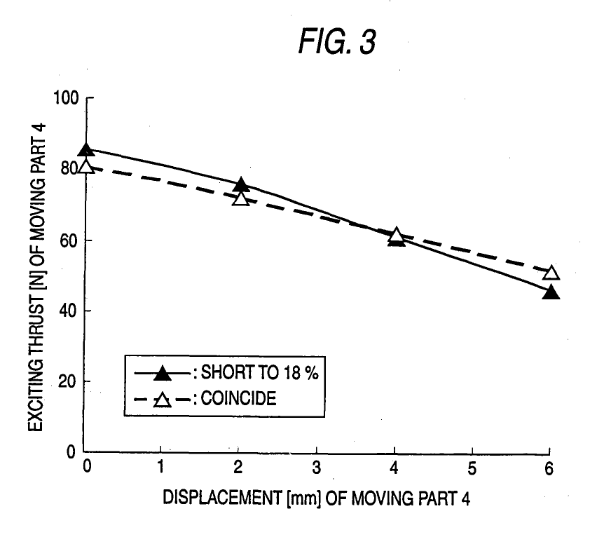

FIG. 3 shows the relationship between the displacements of the moving part 4 and the exciting thrust of the case, in which the distance D is 0% of the width W, that is, in which there are coincidences (“Coincide” in FIG. 3) between the individual end portions 3a and 3b of the back yoke 3 and the two outer-side end portions 11a and 12a of the closest faces 11f and 12f, and the case, in which the back yoke 3 is so arranged that the distance D is made short to 18% (“Short to 18%” in FIG. 3) of the width W.

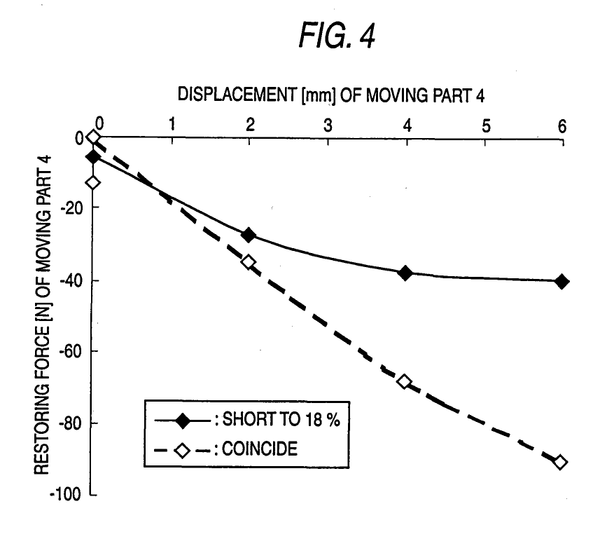

FIG. 4 shows the relations between the displacement of the moving part 4 and the restoring force of the case, in which the distance D is 0% of the width W, that is, in which there are coincidences (“Coincide” in FIG. 4) between the individual end portions 3a and 3b of the back yoke 3 and the two outer-side end portions 11a and 12a of the faces 11f and 12f of the leg portions 11 and 12 of the exciting yoke 1 that are closest to the moving part 4, and the case, in which the back yoke 3 is so arranged that the distance D is made short to 18% (“Short to 18%” in FIG. 4) of the width W.

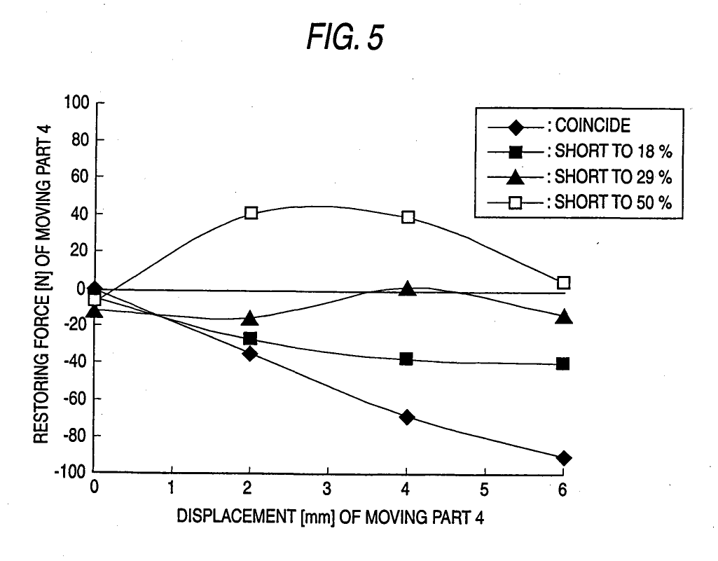

FIG. 5 shows the relations between the displacement of the moving part 4 and the restoring force of the case, in which the distance D is 0% of the width W, that is, in which there are coincidences (“Coincide” in FIG. 5) between the individual end portions 3a and 3b of the back yoke 3 and the two outer-side end portions 11a and 12a of the closest faces 11f and 12f of the leg portions 11 and 12 of the exciting yoke 1 that are closest to the moving part 4, and the cases, in which the back yoke 3 is so arranged that the distance D is made short to 18% (“Short to 18%” in FIG. 5), to 29% (“Short to 29%” in FIG. 5), and to 50% (“Short to 50%” in FIG. 5) of the width W. In the case of “Short to 50%”, there are coincidences between the end portions 3a and 3b of the back yoke 3 and the central portions 11b and 12b of the closest faces 11f and 12f.

In any of FIG. 3, FIG. 4 and FIG. 5, a force for moving the moving part to the outer sides is made positive.

From FIG. 3, it is understood that the exciting thrust draws substantially equivalent curves for the cases, in which the positions of the end portions 3a and 3b of the back yoke 3 are made to coincide with the positions of the two outer-side end portions 11a and 12a of the closest faces 11f and 12f, and in which the back yoke 3 is so arranged that the distance D is made short to 18% of the width W. In short, the curves imply that the exciting thrust is hardly reduced, even if the back yoke 3 is made short.

From FIG. 4, it is understood that the restoring force is substantially equivalent in the vicinity of a neutral range of the moving part displacement of 1 mm or less, but that the restoring force is suppressed small in case the back yoke 3 is made so short that the distance D may be 18% of the width W. For example, the restoring force is reduced to about one half for the displacer of 4 mm.

From FIG. 5, moreover, the restoring force becomes so gradually smaller for the larger distance D that it becomes substantially 0 for the distance D made short to 29% of the width W. It is understood that the force acts as not the restoring one but a nonlinear thrust in case the distance D is made short to 50% of the width W. In cases, however, where the restoring force acts as the nonlinear thrust when the distance D is short to 50% of the width W, the neutral of the moving range becomes unstable so that the resonance adjustment of the mechanical vibration becomes so difficult as to make the motor unstable.

Thus, the back yoke 3 is made so short that its end portions 3a and 3b are positioned at minus leg portions on the axially inner side and at a distance of 30% or less of the axial width W (as referred to FIG. 1 and FIG. 2) of the closest faces to the moving part 4, thereby to suppress the restoring force to a low level without deteriorating a thrust increasing effect of mounting the auxiliary magnets 6 and 7. As a result, the net thrust can be increased to drive the moving part 4 over a wide range.

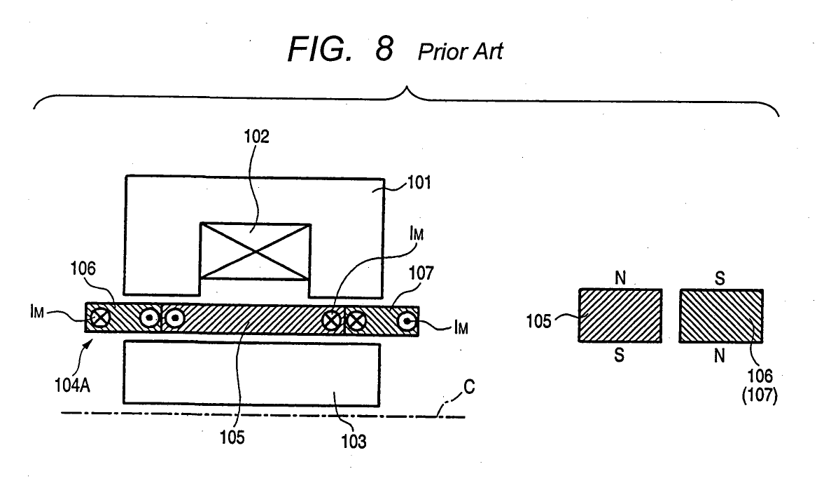

Here in any of the embodiments, the lengths of the auxiliary magnets 6 and 7 along the axial direction are set such that the two end portions of the moving part 4 (i.e., the individual one-end portions of the auxiliary magnets 6 and 7) may not overlap the closest faces 11f and 12f (i.e., the inner sides of the outer-side end portions 11a and 12a) even when the moving part 4 is displaced by the maximum length required as the motor stroke. This is because a reaction force is generated by an equivalent current (as referred to FIG. 8) existing at the outer-side end portions of the auxiliary magnets 6 and 7, in case the auxiliary magnets 6 and 7 are short, thereby to lower the thrust increasing effect.

The invention has been described with reference to certain preferred embodiments thereof. It will be understood, however, that modifications and variations are possible within the scope of the appended claims. For example, in the illustrated embodiments, the exciting yoke 1 is arranged on the radially outer side of the moving part 4, and the back yoke 3 is arranged on the radially inner side of the moving part 4. However, the arrangements of the exciting yoke 1 and the back yoke 3 may be reversed. In the first embodiment, moreover, the junction portions 8 and 9 may be axially shifted from the central portions 11b and 12b of the closest faces of the leg portions 11 and 12 to the moving part 4, although the designing parameters increase. Moreover, the vibrating-type motor according to the invention can be applied to a vibrating-type compressor or the like of a Stirling freezer.

This application claims priority from Japanese Patent Application No. 2007-040998 filed Feb. 21, 2007 and Japanese Patent Application No. 2007-230172 filed Sep. 5, 2007, the content of which is incorporated herein by reference.

What is claimed is:

1. A vibrating-type motor comprising:
a moving part including a main magnet and auxiliary magnets individually junctioned coaxially to axial end portions of the main magnet at junction locations;
an exciting yoke including two leg portions opposed to the moving part through a gap;
an exciting coil wound on the exciting yoke for generating a magnetic flux in the leg portions; and
a back yoke arranged to confront the exciting yoke with the moving part located between the back yoke and the exciting yoke;
wherein outer-side end portions of faces of the leg portions that are closest to the moving part extend past axial end portions of the back yoke.

2. A vibrating-type motor according to claim 1, wherein said exciting yoke is disposed on a radially outer side of the moving part, and wherein the back yoke is disposed on a radially inner side of said moving part.

3. A vibrating-type motor according to claim 1, wherein the exciting yoke is disposed on a inner side of said moving part, and wherein the back yoke is disposed on a radially outer side of said moving part.

4. A vibrating-type motor according to claim 1, wherein the distances between the axial end portions of the back yoke and the outer-side end portions are equal.

5. A vibrating-type motor according to claim 1, wherein the distances between the axial end portions of the back yoke and the outer-side end portions are made 30% or less of the axial width of the faces.

6. A vibrating-type motor according to claim 1, wherein the distance between the junction locations and the distance between the central portions of the faces are equal to each other.

7. A vibrating-type motor according to claim 1, wherein the distance between the junction locations of the main magnet and the auxiliary magnets is larger than the distance between the central portions of the faces.

8. A vibrating-type motor according to claim 1, wherein the axial length of the moving part is larger than the distance between the outer-side end portions of the faces.
